(19) United States
(12) Patent Application Publication
(10) Pub. No.: US 2009/0048859 A1
(43) Pub. Date: Feb. 19, 2009

(54) SYSTEMS AND METHODS FOR SALES LEAD RANKING BASED ON ASSESSMENT OF INTERNET BEHAVIOR

(76) Inventors: Daniel Randal McCarthy, Greenwich, CT (US); Glenn Robert Goad, Cumming, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 12/135,733

(22) Filed: Jun. 9, 2008

Related U.S. Application Data
(60) Provisional application No. 60/933,810, filed on Jun. 8, 2007.

(51) Int. Cl. G06Q 10/00

(52) U.S. Cl. 705/1

(57) ABSTRACT

Methods and systems are presented for assessing sales leads obtained through a lead generation product. One exemplary method comprises receiving consumer information from a potential consumer via a lead generation product; receiving activity information about the potential consumer's interaction with the lead generation product; using the received consumer information and received activity information to develop one or more category scores; and developing a sales lead quality score from the one or more category scores.

### RELATED APPLICATIONS

This application claims the benefit of U.S. Provisional Application No. 60/933,810 filed on Jun. 8, 2007, which is incorporated herein by reference.

### FIELD

The present invention is related to the field of Internet or web-based listing services and, in particular, to a system and method for assessing and ranking leads obtained through such listing services in terms of their potential likelihood of resulting in a successful sale.

### BACKGROUND

On a daily basis millions of consumers are online looking for properties, products, and/or services. Consequently these millions of consumers represent potential sales leads that sellers and advertisers have an interest in approaching in the hope of making a sale. A lead may be thought of as a potential customer of an advertised property, product, or service where that potential customer has expressed some interest in the advertised item and has initiated some form of contact with a sales agent or advertiser associated with that item of interest (even if the contact is anonymous). Thus, a person who contacts a real estate agent, apartment community, or service provider by sending an email inquiry about one or more properties or services that he or she may have seen online represents a lead. Millions of such leads are generated via online activities by potential consumers each day. However, only a very small percentage of this activity actually results in the sale of a property, product, or service.

Part of the difficulty in promoting a lead to a successful sale is that sales agents, advertisers, and other persons and entities interested in receiving sales leads cannot readily distinguish between “good” leads and those potential consumers who, though interested in obtaining more information, are not yet ready to make a purchase. A simple email inquiry generally does not provide the sales agent enough information to identify the “good” or “hot” leads likely to lead to a sale. Accordingly, due to the sheer volume of leads being generated each day, many of the “good” leads go unanswered because the sales agent must arbitrarily decide which leads to pursue and which to ignore. Thus, there is a challenge to identifying good potential sales leads and distinguishing such leads from leads that are less likely to result in a successful sale.

### SUMMARY

Systems and methods for assessing sales leads obtained through a lead generation product are disclosed. For example, in certain embodiments a method comprises receiving consumer information from a potential consumer via a lead generation product, such as, for example, a Web site. In addition, activity information about the potential consumer's interaction with the lead generation product is also received. The received consumer information and received activity information is used to develop one or more category scores. One or more category scores are then used to develop a sales lead quality score.

In another exemplary embodiment, the category scores are used to measure the relevance of a product or service to the consumer, the consumer's level of interest in a product or service, and/or the consumer's urgency in wanting to purchase a product or service. These category scores can be combined in a weighted fashion for a particular industry to develop a composite sales quality lead score.

These embodiments are mentioned not to limit or define the disclosure, but to provide examples of embodiments to aid understanding thereof. Embodiments are discussed in the Detailed Description, and further description is provided there. Advantages offered by the various embodiments may be further understood by examining this specification.

### BRIEF DESCRIPTION OF THE DRAWINGS

These and other features, aspects, and advantages of the present disclosure are better understood when the following Detailed Description is read with reference to the accompanying drawings, wherein:

FIG. 1 is a system diagram showing an exemplary system architecture for implementation of certain embodiments.

FIG. 2 is a flow diagram showing an overview of the data collection and analysis process for an certain embodiments.

FIG. 3 is a flow diagram showing a data collection process in certain embodiments.

FIG. 4 is a flow diagram showing a data analysis and reporting process in certain embodiments.

FIG. 5 shows an illustrative email message reporting information pertaining to a potential lead in certain embodiments.

### DETAILED DESCRIPTION OF EXEMPLARY EMBODIMENTS

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

Embodiments of the present invention relate to a Lead Quality Metrics (“LQM”) solution directed at the problem of assessing and ranking leads in terms of their potential likelihood of resulting in a successful sale. In one embodiment, a goal of the LQM solution is to assist lead recipients in their prioritization and evaluation of individual leads they receive. For example, a potential lead can demonstrate interest in an advertised item by accessing information about the item through a Web site on the Internet. In one embodiment, to assess and rank leads, the LQM system analyzes 1) the user's activities on the Web site prior to lead submission and 2) lead submission patterns. Information about consumer behavior can be collected as the potential consumer navigates through a Web site and can be used to rank potential sales leads with respect to likelihood of leading to a successful sale.

A lead quality score with respect to a potential sales lead can be created. The lead quality score can be based on one or more areas of interest, such as relevancy, engagement and immediacy, and a separate score can be created for each area of interest. Relevancy can be the closeness of a product or service match to what the user is looking for. Engagement can be the interest of the user in finding a product or service. Immediacy can be the urgency of finding a product or service for the user.

The relevancy, engagement, and immediacy scores can be weighted differently or the same and can be combined into a single lead quality score. In one embodiment, once the lead quality score has been computed, the system using computer software ranks and rates this sales lead in comparison to all other sales leads and thereby gives the advertiser, such as the realtor, an ordered list of sales leads ranked in terms of likelihood of leading to a successful sale. In one embodiment, the system provides an advertiser, such as a realtor, with leads via e-mail. In such embodiment, the e-mail can contain information about the product, such as a home, information about the consumer, and the lead quality metrics, such as a composite score and further information on the relevancy metric, engagement metric, and immediacy metric.

In addition, an embodiment can incorporate feedback from the market on exactly what happened with any particular lead to continually refine the scoring criteria and the ranking algorithms. Thus, the heuristics used to measure criteria such as relevancy, engagement, and immediacy can evolve over time based on feedback of the correlation between a lead's scores in each area and the sales agent's likelihood of a resulting sale. This data is gathered through surveying lead recipients. This feedback loop provides a mechanism to push lead information to advertisers and provide a feedback mechanism alongside the delivery of the information.

While examples have been provided relating to the real estate market, this technology is not limited to the real estate market and can be applied to any online search product where consumer behavior can be mapped and recorded.

### Architecture of an Illustrative System

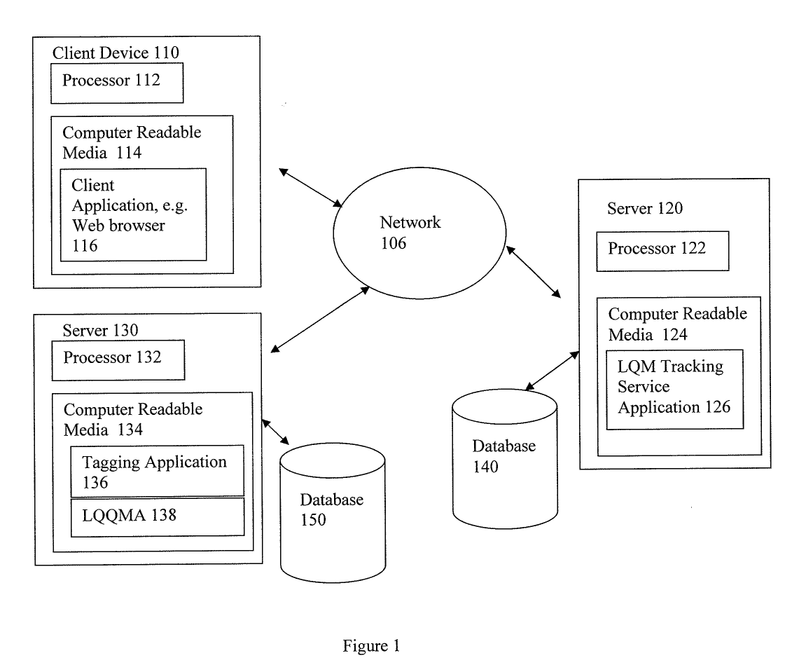

The system 100 shown in FIG. 1 illustrates one embodiment for implementation of the invention and includes client devices 110 (there may be multiple client devices) that can communicate with one or more server devices 120, 130 over a network 106. The network 106 shown in FIG. 1 comprises the Internet. In other embodiments, other networks, such as an intranet, may be used instead. In one embodiment, a consumer interacts with a Web site, which could reside on server 130, through client device 110 connected to network 106.

The client devices 110 shown in FIG. 1 each include a computer-readable media 114, for example a random access memory. The processor 112 executes computer-executable program instructions stored in memory 114. Such processors may include a microprocessor, an ASIC, state machines, or other processor, and can be any of a number of suitable computer processors, such as processors from Intel Corporation of Santa Clara, Calif. and Motorola Corporation of Schaumburg, Ill. Such processors include, or may be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor 112 of client 110, with computer-readable instructions.

Client devices 110 and server devices 120, 130 can be coupled to a network 106 through wired, wireless, or optical connections. Client devices 110 may also include a number of external or internal devices such as a mouse, a CD-ROM, DVD, a keyboard, a display device, or other input or output devices. Examples of client devices 110 are personal computers, digital assistants, personal digital assistants, cellular phones, mobile phones, smart phones, pagers, digital tablets, laptop computers, Internet appliances, and other processor-based devices. In general, the client devices 110 may be any type of processor-based platform that operates on any suitable operating system, such as Microsoft® Windows® or Linux, capable of supporting one or more client applications. For example, the client device 110 can comprise a personal computer executing a client application 116, which can be contained in memory 114 and can comprise without limitation, for example, an email application, an instant messenger application, a presentation application, an Internet browser application, an image display application, an operating system shell, and other applications capable of being executed by a client device. Client applications may also include client-side applications that interact with or accesses other applications (such as, for example, a Web-browser executing on the client device 110 that interacts with a remote e-mail server to access e-mail).

In certain embodiments, the LQM Tracking Service 126 discussed herein could reside on server 120. LQM 126 is an application that assists requesting entities, such as advertisers for example, by analyzing information supplied by a potential consumer as well as information about how the consumer interacts with, for example, a Web site, and develops one or more scores that gives the advertiser an assessment of the quality of the potential sales lead.

In certain embodiments, the Lead Quality Metric Management Application (“LQMMA”) 138 could reside on server 130. LQMMA 138 is an application that assists requesting entities (also sometimes referred to as “subscribers”) in viewing and managing data that is utilized and computed by LQM 126 in the lead quality assessment process.

Server 120 interacts with database 140; similarly server 130 interacts with database 150. Databases 140, 150 may take any number of structured or unstructured forms as is well-known to those of skill in the art.

In an illustrative example, a subscriber requests that LQM 126 tag and collect data as potential consumers navigate the subscriber's Web site using a Web browser on the consumer's client device 110. LQM 126 then starts collecting data both in the form of data entered by the consumer as well as data about the consumer's Web interaction activities, e.g. how many photographs of an apartment did the consumer look at. Such data can be collected over a period of time during several different consumer Web interaction sessions and stored in a cookie on client device 110. Once the data is collected, LQM 126 then analyzes the data to develop various scores of interest and rank the potential lead as discussed further below. LQM 126 then stores the analysis results in database 140 and also communicates them back to the subscriber for viewing through the LQMMA application 138 and possible storage in database 150. After pursuing the lead, the subscriber may then use LQQMA 138 to interact with LQM 126 to provide feedback on how accurate the analyzed results turned out to be, thereby possibly refining the data collection and analysis process to better suit the needs of the subscriber.

### Illustrative Data Collection and Analysis

Currently available lead generation products take information that is provided by the consumer to rate and rank a lead. However, knowledge of a particular industry may also be utilized to develop various scores for categories of interest—such as relevancy, engagement, and immediacy—to assess the potential readiness of a consumer to make a purchase. For example, for consumers obtaining information about a product from a Web site, these scores and this readiness assessment may be developed based on, among other things, the consumer's activity on the site, how the consumer arrived at the site, as well as the information provided by the consumer while at the site. In addition, meta-information about the information provided by the consumer is also important. The fact that the consumer provided a significant amount of detailed information about his or her purchase interests may be of more importance than the actual information provided in assessing that consumer's readiness to make a purchase.

Based on the consumer's activities at the Web site in addition to the actual information provided, one may assess and rank leads in terms of various scores, of which relevancy, engagement, and immediacy are examples. For example, a relevancy score assesses how relevant the property, product, or service is based on how the consumer conducted his or her Web search. Thus, in addition to knowing the actual zip code of a property of interest, it may also be important to know whether the consumer identified the property by specifically entering the pertinent zip code as a search parameter or if the consumer engaged in a wide-ranging search to identify the property of interest. The fact that the consumer entered a specific zip code—and not just the actual zip code itself—may establish that a property of interest is particularly relevant to this consumer and could result in a high relevancy score. Similar considerations apply to the other scores as well.

Once the various scores or interest are developed, knowledge of the particular industry may be utilized to combine them into a composite lead quality score and thereby yield a ranking of the lead under consideration. For example, in the real estate market, it may be that the relevancy score is of more importance than the engagement and/or immediacy scores. Thus, as a function of the market sector for which the leads are being developed, the various scores may be given different weights—including zero weight if appropriate—and combined to arrive at the composite lead quality score and an overall ranking of the lead.

For example, a consumer may examine properties on a real estate agent's Web site by entering as search terms a specific neighborhood, a narrow price range, and a specific number of bedrooms and bathrooms. For the lone property returned in the search, the consumer may looks at every photograph of this property available at the site and emails a link to the site to several people. The scoring system may determine high scores for relevancy (the consumer searched for and found a very specific property), engagement (the consumer spent a long time looking at the Web site and the photographs), and immediacy (the consumer wants other persons to be aware of his potential new home). If the sales agent then receives a simple email inquiry from the consumer asking for more information about the property, in the absence of theses scores the sale agent may not be able to distinguish this inquiry from the multiple other inquiries he or she has received that day and may potentially ignore it for an arbitrary reason (e.g. it appears last in his list of email inquiries). However, when these scores along with a composite lead quality score is attached to the email inquiry or sent in a separate email by the technology of this invention, the sales agent can identify this consumer as a person who potentially is ready to buy that particular property immediately and can take steps to focus his activities on assisting this consumer. In this case, the overall lead quality score may be used to provide the ranking of the lead while the individual relevancy, engagement, and immediacy scores may allow the sales agent to assess the “hotness” of the lead.

In addition, the consumer may visit the Web site several different times and each time generate an email inquiry asking for more information about the property. Embodiments of the present invention match the consumer's subsequent Web searching behavior to the previous information gathered and use it to refine the various individual and composite scores, thereby continually refining the lead ranking for this consumer with each pertinent Web interaction.

### Illustrative Lead Quality Metric Application Web Interaction Process

In one embodiment, the Lead Quality Metric Application can be implemented through “tagging” of a Web site with LQM “event markers.” The tagging consists of applying snippets of application code that are transparent to the user to activities within the Web site that serve as inputs to the Relevancy, Engagement, and Immediacy metrics categories. The following entities interact in the data collection and analysis process:

Consumer. Any user of a Web site that has LQM tagging implemented.

Web site. A consumer-oriented Web application that has a specific set of transaction goals for the user. Examples of transaction goals include sales lead generation for a property, requesting information about an automobile, submitting an e-commerce sales order, etc.

Lead Quality Metrics (LQM) Tracking Service. The tracking service is a hosted Web-based application that records user interactions within a Web site; analyzes user activities to determine Relevancy, Engagement, and Immediacy metrics; and delivers metrics to the requesting application.

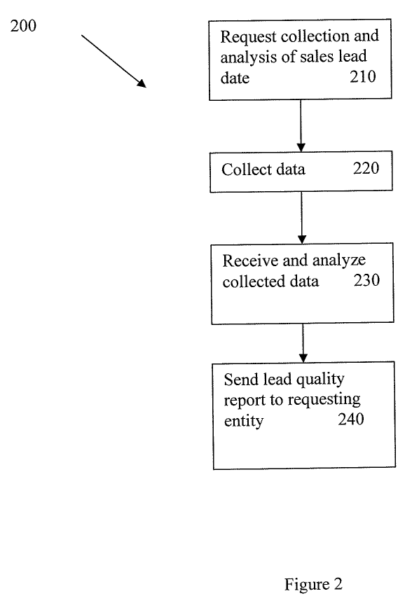

Flow chart 200 in FIG. 2 provides a broad overview of the process of assessing and analyzing sales leads. At block 210, a requesting entity such as, for example, the owner of a Web site hosted on server 130, requests collection and analysis of sales lead data. The Web site owner, for example, instructs the provider of the LQM service to provide this service with respect to the owner's Web site. The LQM service provider will then work with the Web site owner to identify the consumer information of interest and to implement tagging of the Web site according to known tagging methods to capture this information.

At block 220 the pertinent data is then collected. A potential consumer accesses the Web site and, as he or she navigates through the site, various data is collected in accordance with the tagging approach that has been implemented. Certain data will be collected and stored in a cookie according to known methods. Storing information in a cookie permits the collection of data over several different browsing sessions on the consumer's client device 110.

At block 230, the collected data is then sent to and analyzed by LQM 126. Sending of the data to the LQM 126 is triggered when the potential consumer indicates that he or she has reached a searching goal. For example, if the consumer self-identifies and asks for further information or asks for a salesperson to contact him or her, such a request would trigger the data delivery to LQM 126 for analysis.

At block 240, LQM 126 then sends a lead quality report to the requesting entity, such as, for example, a real estate agency with a Web site listing apartments and/or houses for sale, lease or rent.

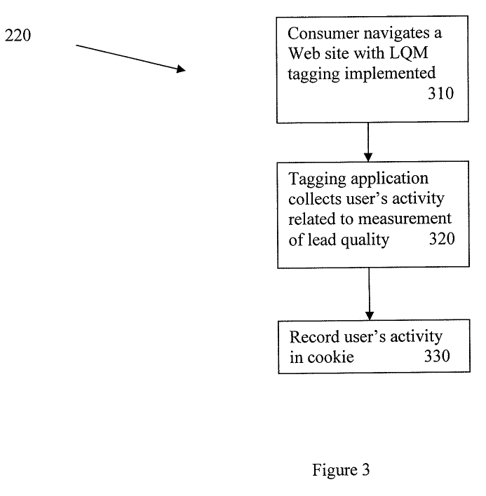

The data collection of block 220 is illustrated more fully in the flowchart on FIG. 3. Data is collected as a user or potential consumer interacts with a lead generation product, such as a Web site, as shown in block 310. In the case of a Web site, the user accesses a Web site implemented on, for example, server 130 through client application 116 in the form of a Web browser.

As shown in block 320, an application 136 resident on server 130 permits tagging of the user's interaction. Once the requesting entity decides which consumer information is of interest, tagging of the Web site to capture this information is implemented according to known methods.

The tagging application 136 collects information about the user and his interaction and, at block 330, records the information. In one embodiment, the tagging application collects the information in a local cookie on the user's client device 110. Cookie technology is well-known to those of skill in the art and can be used to match the consumer's subsequent Web searching behavior to information gathered from previous Web searching activity.

In certain embodiments, the collected data permits the LQM application 126 to develop scores in the following categories: Relevance, Engagement, Immediacy. In one embodiment applicable to generation of leads in the real estate market, the types of data that are tagged at block 320 and recorded at block 330 may be organized into categories that permit development of Relevance, Engagement, and Immediacy scores. Such categories of data are illustrated in Tables 1-3.

The following illustrative Table 1 shows describes various data that can be used to develop a relevancy score useful in certain embodiments:

### Relevancy Data

TABLE 1

| Metric Data Item | Description |
|---|---|
| Narrowing of map | Property location is within a “reasonably |
| | narrow” area being viewed on map (zoom |
| | level) |
| Match to user's search location | City, state, zip |
| Proximity to user's search point-of-interest | Distance from college, military base, street |
| | address (e.g. employer) |
| Match to user's search price criteria | (Include scoring based on whether search |
| | includes price criteria or not) |
| Match to user's other search facets | Property type, bedrooms, bathrooms, square |
| | footage, etc. |
| Match to user's search keywords | Description/data contains search terms |
| | (keywords) entered by user |
| Views of nearby properties | Views of detail information for other “nearby” |
| | properties (within a certain distance) |
| Leads for nearby properties | Contact requests for other “nearby” properties |
| Session access point (referrer) | Referring Web site, e.g. search engine, direct- |
| | entry of URL, link from partner, etc. |
| Search engine keywords | Keywords entered by user on referring search |
| | engine |

The following illustrative Table 2 describes various data that can be used to develop an engagement score useful in certain embodiments:

### Engagement Data

TABLE 2

| | |
|---|---|
| Metric Data Item | Description |

Search Actions

| | |
|---|---|
| Properties viewed | All properties viewed (total in user history or |
| | total for current session) |
| Searches performed | (total in user history, or total for current |
| | session) |
| Property views vs. total results returned (search | Ratio of views of unique properties compared |
| impressions) | to total “result impressions” available to user |
| | (total in user history, or total for current |
| | session) |
| Map refinement taken | User adjusted search results map in some way |
| Search refinement taken | User adjusted (filtered) search results in some |
| | way |
| Sort criteria used on search results | Primary sort method by which search results |
| | are being viewed (e.g. price low-to-high) |
| Search results sets viewed | Results “pages” viewed by user |

Listing Actions

| | |
|---|---|
| Views of property details | Displayed detail information |
| Send to a friend | Forwarded to other email addresses |
| Send to mobile | Forwarded via cell phone messaging |
| Saved property | Stored for future reference |
| Detail-view access point (referrer) | Referring call-to-action from which user |
| | viewed listing details, e.g. Retriever email, |
| | agent/office detail, search results, results map, |
| | Featured listing position, etc. |
| Viewed photos | Opened image(s), photograph(s) |
| Viewed floor plan | Opened floor plan image(s) |
| Viewed virtual tour | Opened “virtual tour” presentation |
| Viewed rich media | Opened video, presentation, etc. |
| Changed payment calculator assumptions | Adjusted “what-if” scenarios e.g. payment |
| | basis |
| Viewed unit availability | Opened unit/floor plan availability info |
| Viewed location information | Opened neighborhood statistical information |
| Viewed comparables | Opened nearby comparable home-sales |
| | information |
| Viewed brochure | Opened printable “brochure” details |

Contact Actions

| | |
|---|---|
| Viewed driving directions | Displayed property directions/map |
| Printed driving directions | Initiated print action for property |
| | directions/map |
| Viewed promotional offer | Displayed property sales incentive(s) |
| Requested automated directions (routing) | Obtained “custom” driving directions, e.g. with |
| | user-entered starting point |
| View advertiser info | Displayed details for sales agent/brokerage, |
| | leasing office, etc. |
| Contact advertiser | Contacted sales agent/brokerage, leasing |
| | office, etc. |
| Abandoned contact | Previously initiated, but did not complete |
| | contact |
| Contact-access point (referrer) | Referring call-to-action via which user initiated |
| | the lead process, e.g. search results, results |
| | map, property detail, driving directions, |
| | promotional offer, etc. |
| Clickthrough to advertiser's Web site | Opened Web site link to advertiser's “external” |
| | Web site (URL) |

The following illustrative Table 3 describes various data that can be used to develop an immediacy score useful in certain embodiments:

### Immediacy Data

TABLE 3

| Metric Item Data | Description |
|---|---|
| Time to move | Time remaining until preferred or expected |
| | move-in date/deadline |
| Frequency of site visits | (Total) sessions to lead-source Web site |
| Time on site | (Total) time spent on lead-source Web site |
| Leads generated | (Total) contact requests created by user |
| Extended contact | Lead included “extended” contact info such as |
| information provided | phone number, mobile phone number, etc. |

### Illustrative Lead Quality Scoring

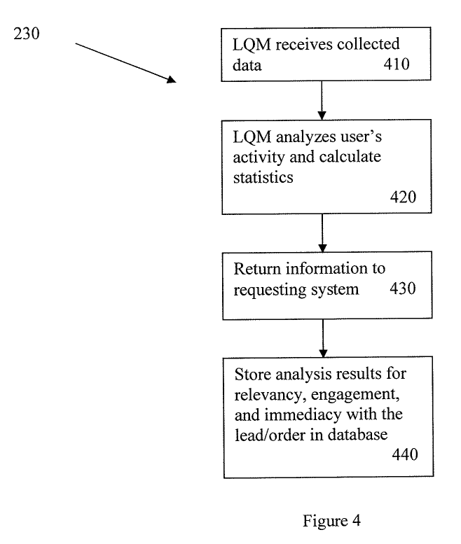

Utilizing the metric data items listed, for example, in Tables 1-3, the LQM 126 resident on server 120 calculates and distributes selected lead quality scores which provide analytical insight into the overall sense of the lead's “temperature.” In particular, as shown in block 220 of FIG. 2, data is analyzed by the LQM 126. The data analysis process of block 220 is shown in more detail in FIG. 4. In an exemplary embodiment, LQM 126 receives the tagged data that tagging application 136 collected, including any information collected over multiple Web searches and stored in a local cookie, along with a request to analyze the tagged data for relevancy, engagement, and immediacy, as shown at block 410 of flowchart 400.

At block 420, LQM 126 analyzes the user's activity and calculates statistics. More particularly, LQM 126 can develop multiple levels of analysis based on 1) the individual data items, which analysis may take the form of per-item metric values, 2) the categories, where the analysis results in aggregate scores for metrics within each of, for example, the Relevancy, Engagement, and Immediacy categories, and 3) a weighted composite assessment of the categories in the form of an “overall” (at-a-glance) lead quality score, which may be computed from any one or more of the category scores or individual data item metrics.

For example, the analysis with respect to the relevancy category addresses measures such as: How closely does this home match what the consumer is looking for? The LQM creates this score for the lead based on how relevant the property is to a potential consumer based on how that potential consumer conducted his or her search on the Web. The criteria for creating this score is based on, for example: 1) area searched (e.g. a metro area or a specific zip code) 2) did the potential consumer use the map feature to zoom in on a geographic area, 3) how broad was the price range that the potential consumer searched, 4) what amenities did the potential consumer ask for in the search, etc. For example, if a user searches on the exact zip code that the property is located in, a weight of 5 may be applied. If the property is only within the city represented by the exact search a weight of only 1 would be applied. Other metrics include how closely the property matches the user's price criteria, did the property match a facet criteria, does the property contain keywords used by the individual in their search, and similar considerations.

By way of further example, the analysis with respect to the engagement category addresses measures such as: How invested is this individual in finding a property, product, or service, e.g. a home? The user's level of engagement is measured through the activities taken against the listing such as emailing the listing to a friend, sending the address to a mobile device, amount of time spent looking at the listing, amount of times the user viewed the listing. LQM 126 gives the lead a score in this area based on how engaged the consumer was with the property, product, or service. For example, for home sales the criteria for creating this score is based on things like: 1) how many photos did the potential consumer view, 2) did the potential consumer look at additional information, such as the neighborhood information, 3) did the potential consumer look at the list of recently sold properties, 4) did the potential consumer map the property, etc.

By way of further example, the analysis with respect to the immediacy category addresses measures such as: How urgent is finding a property, product, or service (e.g. a home) for this user? Immediacy is measured through responses to entries such as the time-frame during which the property/product, or service is need (provided with a lead), length of time spent on the site, and number of leads generated. For example, for home sales, LQM 126 gives the lead a score in this area based on the potential consumer's other activities with respect to other properties. The criteria for creating this score is based on things like: 1) how many other properties did the potential consumer view, 2) of those properties how many did the potential consumer send a lead on, 3) did the potential consumer request a brochure, 4) did the potential consumer send this property information to other people or to a mobile phone, etc.

In addition to individual data item metric scores and category scores, LQM 126 can also compute an “overall” (at-a-glance) lead quality score, which may be computed from any one or more of the category scores or individual metrics. In particular, this composite score can be computed by combining selected individual data item scores and/or category scores on a weighted basis, where the weighting used can depend on the specific industry within which the lead is being generated.

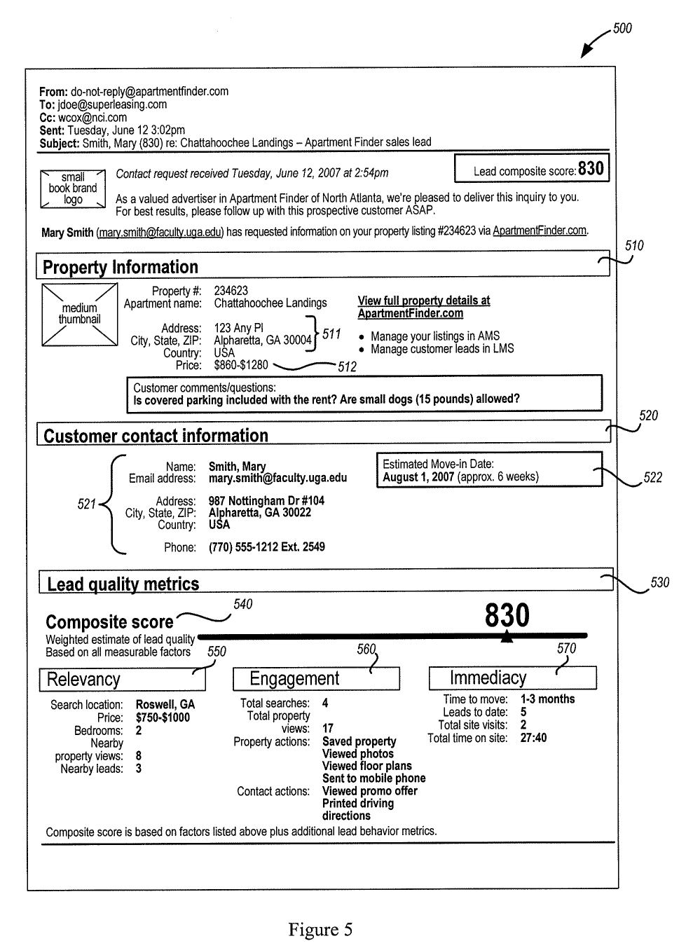

In one embodiment, the LQM Tracking Service 126 provides an advertiser, such as a realtor, with leads via e-mail. The LQM 126 can provide the advertiser with the top lead or the several of the top-ranked leads based on the lead composite scores. An illustrative email 500 is shown in FIG. 5. Such an e-mail can contain product information 510, such as, for example, information about real estate. In the example shown in FIG. 5, the email can contain the basic listing information about the property information including address 511 and pricing information 512. The email can also contain consumer information 520, such as contact information 521 and product specific information 522, e.g. estimated move-in date. The illustrative email in FIG. 5 also contains lead quality metrics 530. As shown in FIG. 5, the composite score 540 is includes as well as specific relevancy 550, engagement 560, and immediacy 570 scores.

At block 440, collected and analyzed data is stored both in database 140 by LQM 126 and in database 150 by the requesting entity. Each of LQM and the requesting entity may store all or any subset of the collected and analyzed data as may be of interest.

### Illustrative Lead Quality Metric Management Application

In one embodiment, the Lead Quality Metric Management Application (LQMMA) 138 enables subscribers to manage and view data utilized in the lead quality metric determination process. Subscribers are organizations that use the LQM Tracking System to monitor & analyze lead behavior on their Web applications. In one embodiment, LQMMA 136, which resides on, for example, server 130, includes the following functionality:

Analytics. Extensive functionality for refinement of heuristics to determine lead quality is a key component of the Lead Quality Metric application. Within the LQMMA 136, subscribers can be offered many views of lead quality data and scores as well as consumer activity as reflected in the individual data items, the category scores, and the composite sales lead data score. This functionality permits the subscriber to refine the heuristics.

Surveying. Through this functionality, subscribers can solicit feedback on correlation of LQM metrics to real-world lead conversion activities, e.g. contact- or lead-closure rates. Subscribers can then utilize this feedback to improve the data and scores returned by the LQM Tracking System 126. Such feedback information can be stored in database 150.

Metric Item Management. Enables subscribers to adjust a score by metric category (Relevancy, Engagement, Immediacy) or individual data item in order to refine the heuristics used to analyze lead quality.

User Management. Allows subscribers to manage the users of the LQM application, including creation of new users and assignment of role-based user permissions.

### GENERAL

Embodiments of the present invention may comprise systems having different architecture and methods having different information flows than those shown in the Figures. The systems shown are merely illustrative and are not intended to indicate that any system component, feature, or information flow is essential or necessary to any embodiment or limiting the scope of the present disclosure. The foregoing description of the embodiments has been presented only for the purpose of illustration and description and is not intended to be exhaustive or to limit the disclosure to the precise forms disclosed. Numerous modifications and adaptations are apparent to those skilled in the art without departing from the spirit and scope of the disclosure.

What is claimed is:

1. A method of assessing sales leads obtained through a lead generation product, said method comprising:
receiving consumer information from a potential consumer via a lead generation product;
receiving activity information about the potential consumer's interaction with the lead generation product;
using the received consumer information and received activity information to develop one or more category scores; and
developing a sales lead quality score from the one or more category scores.

2. The method of claim 1 wherein the one or more category scores comprises at least one of the following categories: relevancy, engagement, immediacy.

3. The method of claim 1 wherein the lead generation product comprises a Web site.

4. The method of claim 1 wherein developing a lead sales quality score further comprises weighting each of the one or more category scores and combining the weighted category scores to obtain a composite sales lead quality score.

5. The method of claim 1 further comprising reporting the sales lead quality score to a requesting entity.

6. The method of claim 5 further comprising receiving feedback from the requesting entity regarding the quality of the reported sales lead quality score; and
modifying in response to the feedback one or more of the steps of:
using the received consumer information and received activity information to develop one or more category scores; and
developing a sales lead quality score from the one or more category scores.

7. The method of claim 1 further comprising
receiving industry-specific information;
utilizing the industry-specific information to modify one or more of the steps of:
using the received consumer information and received activity information to develop one or more category scores; and
developing a sales lead quality score from the one or more category scores.

8. A method of assessing sales leads obtained through a Web site, said method comprising:
receiving consumer information from a potential consumer via a Web site;
receiving activity information about the potential consumer's interaction with the Web site;
using the received consumer information and received activity information to develop a lead category score;
using the received consumer information and received activity information to develop an engagement category score;
using the received consumer information and received activity information to develop an immediacy category score and
developing a sales lead quality score from a weighted combination of the lead, engagement, and immediacy category scores.

9. The method of claim 8 further comprising receiving industry-specific information; and
utilizing the industry-specific information to modify one or more of the steps of:
using the received consumer information and received activity information to develop a relevancy category score;
using the received consumer information and received activity information to develop an engagement category score;
using the received consumer information and received activity information to develop an immediacy category score; and
developing a sales lead quality score from a weighted combination of the relevancy, engagement, and immediacy category scores.

10. The method of claim 8 further comprising reporting the sales lead quality score to a requesting entity;
receiving feedback from the requesting entity regarding the quality of the reported sales lead quality score; and
modifying in response to the feedback one or more of the steps of:
using the received consumer information and received activity information to develop a relevancy category score;
using the received consumer information and received activity information to develop an engagement category score;
using the received consumer information and received activity information to develop an immediacy category score; and
developing a sales lead quality score from a weighted combination of the relevancy, engagement, and immediacy category scores.

11. A computer-readable medium on which is encoded program code, the program code comprising
program code for receiving consumer information from a potential consumer via a lead generation product;
program code for receiving activity information about the potential consumer's interaction with the lead generation product;
program code for using the received consumer information and received activity information to develop one or more category scores; and
program code for developing a sales lead quality score from the one or more category scores.

12. The computer-readable medium of claim 7 wherein the one or more category scores comprises at least one of the following categories: relevancy, engagement, immediacy.

13. A computer-readable medium on which is encoded program code, the program code comprising
program code for receiving consumer information from a potential consumer via a Web site;
program code for receiving activity information about the potential consumer's interaction with a Web site;
program code for using the received consumer information and received activity information to develop a relevancy category score;
program code for using the received consumer information and received activity information to develop an engagement category score;
program code for using the received consumer information and received activity information to develop an immediacy category score; and
program code for developing a sales lead quality score from a weighted combination of the relevancy, engagement, and immediacy category scores.
